(19) United States
(12) Patent Application Publication
(10) Pub. No.: US 2009/0080315 A1
(43) Pub. Date: Mar. 26, 2009

(54) OPTICAL INFORMATION RECORDING AND REPRODUCING APPARATUS AND METHOD OF OPTICALLY RECORDING AND REPRODUCING INFORMATION

(75) Inventors: MASAHIRO KANAMARU, Fuchu-shi (JP); Kazuki Matsumoto, Kawasaki-shi (JP)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: KABUSHIKI KAISHA TOSHIBA

(21) Appl. No.: 12/233,452

(22) Filed: Sep. 18, 2008

(30) Foreign Application Priority Data
Sep. 26, 2007 (JP) 2007-249649

(51) Int. Cl. G11B 7/00

(52) U.S. Cl. 369/103; G9B/7

(57) ABSTRACT

An optical recording and reproducing apparatus according to the present invention utilizes an angle multiplexing interfering method to record multiple pieces of recording data on an optical recording medium. Recording conditions for the multiple recording and management information such as addresses are recorded in the same book according to a coaxial interfering method. In a reproduction mode, the management information is read from a hologram formed according to the coaxial interfering method. The management information is utilized to quickly read the recording data from a hologram formed according to the angle multiplexing interfering method.

### CROSS-REFERENCE TO RELATED APPLICATIONS

This application is based upon and claims the benefit of priority from prior Japanese Patent Application No. 2007-249649, filed Sep. 26, 2007, the entire contents of which are incorporated herein by reference.

### BACKGROUND OF THE INVENTION

1. Field of the Invention

The present invention relates to a hologram type optical information recording and reproducing apparatus which records information on a holograph, particularly a digital volume holograph and which reproduces information from a hologram, as well as a recording and reproducing method of recording and reproducing information on and from the hologram.

2. Description of the Related Art

Optical information recording apparatuses are information recording apparatuses capable of recording data of a large capacity such as high-density images. As optical information recording apparatuses, photomagnetic information recording apparatuses, optical phase change type information recording apparatuses, and apparatuses such as CD-Rs have been put to practical use. However, there still has been a growing demand for an increase in the capacity of information that can be recorded on an optical recording medium. To allow optical information of a high capacity to be recorded, JP-A 2003-178460 (KOKAI) proposes a hologram type optical information recording apparatus utilizing holography, particularly digital volume holography.

In general, with an optical information reproducing and reproducing apparatus using holography, in a recording mode, an information light beam containing information as a two-dimensional pattern and reference light beam interfere with each other inside the optical recording medium to record the information as interference fringes. In a reproduction mode, the recorded interference fringes (hologram) are irradiated only with the reference light beam to extract a diffraction image from the interference fringes as a two-dimensional pattern. The information is reproduced from the pattern. This optical recording and reproducing apparatus has the advantage of allowing optical information of a high capacity to be input and output at a high speed.

With the optical recording and reproducing apparatus using digital volume holography, the interference fringes are three-dimensionally recorded as a digital volume holograph by positively utilizing the volume of the optical recording medium in a thickness direction. Thus, the optical recording and reproducing apparatus recording the digital volume holograph is characterized by improving diffraction efficiency to enable multiple pieces of information to be recorded in the same area inside the optical recording medium, allowing a further increase in recording capacity.

With the optical recording and reproducing apparatus using holography, as described above, in the recording mode, information to be recorded is added to the information light beam as a two-dimensional pattern. The information light beam and the reference light beam interfere with each other in the recording medium to record the information as interference fringes (hologram). In the reproduction mode, the recorded hologram is irradiated only the reference light beam in the same arrangement (orientation) as that used in the recording mode. The diffraction image (pattern) is thus extracted from the hologram to read the recorded information. In the reproduction mode, the orientation (irradiation conditions such as an irradiation angle and an irradiation position) of the reference light beam emitted to the hologram may deviate slightly from that used in the recording mode. Then, even though the recorded hologram is irradiated with the reference light beam, the phase of the reference light beam fails to match the phase of the hologram, preventing the diffraction image from being obtained. The orientation of the reference light beam preventing the obtainment of the diffraction image can be used to record interference fringes resulting from interference with other information light beams. Consequently, multiple pieces of two-dimensional information can be recorded in the same area (the same book) inside the optical recording medium according to the orientation of the reference light beam.

Thus, the optical recording and reproducing apparatus using the holography enables multiple pieces of information to be recorded utilizing the matching between the phase of the interference fringes and the phase of light. However, this needs to be strictly set in reading conditions for reading in the reproduction mode, reducing tolerances for reading.

For the hologram recording and reproducing method, roughly two types of methods have been proposed. One of the schemes is an angle multiplexing scheme, and the other is a coaxial scheme. The angle multiplexing scheme is common and has been proposed since the hologram recording was initially proposed. The angle multiplexing scheme is known to irradiate the recording medium with the information light beam containing the information to be recorded and the reference light beam, at difference incident angles to record the interference fringes. With this scheme, the incident angle of the reference light beam needs to be exactly equal to that of the reference light beam for the recording mode. With the angle multiplexing scheme, if the strict conditions fail to be met when a recording area is irradiated with the reference light beam, the desired information light beam disadvantageously fails to be reproduced. However, this selectivity of the incident angle can advantageously be utilized to record multiple piece of information in one volume.

The other scheme, the coaxial scheme, is known as a method of coaxially transferring the information light beam and the reference light beam so that the information light beam and the reference light beam enter the recording medium perpendicularly, thus allowing the coaxial information and reference light beams to record a hologram. With the coaxial scheme, a light beam from a light source enters a spatial light modulator so that the reference light beam is obtained from an outer peripheral portion of the spatial light modulator, whereas the information light beam is obtained from an inner peripheral portion of the spatial light modulator which is surrounded by the outer peripheral portion. With the coaxial scheme, in the reproduction mode, when the reference light beam is slightly shifted parallel from the spot of the beam for the reproduction mode, the information light beam fails to be obtained. This shift selectivity is utilized to record multiple pieces of information in different areas (different books).

The two schemes involve a transmissive optical system that detects a transmitted light beam and a reflective optical system that detects a reflected light beam. Advantageously, a servo scheme used for DVDs or CDs can be used directly for an apparatus according to the reflective and coaxial scheme. In this case, the optical system is also simplified. However, the reflective scheme disadvantageously records otherwise unwanted interference fringes on the recording medium, wasting the recording medium. The transmissive angle multiplexing scheme is assumed to be desirable for efficiently using the recording medium to increase the capacity of recordable information.

A servo problem with the transmissive angle multiplexing scheme has been pointed out. No optimum servo system has been established for transmissive optical discs; this problem remains unsolved. In the recording mode, an angle interval (an angle to be selected) for multiple recording is important. However, the angle interval depends on mechanical accuracy and can be adequately set by improving this mechanical characteristic. However, in the reproduction mode, an absolute angle is important, and a slight deviation in very small angle may disadvantageously prevent a reproduction light beam from being obtained. Furthermore, no control method for efficiently irradiating a target recording spot with the reference light beam has been provided.

### BRIEF SUMMARY OF THE INVENTION

According to an aspect of the present invention, there is provided an optical information reproducing apparatus comprising:

an optical recording medium having an optical recording layer in which a first hologram is formed by optical coaxial interference and in which a second hologram is formed by angle multiplexing interference in an area in which the first hologram is recorded;

a light source which generates a coherent light beam;

a first optical system which applies a first reference pattern to the light beam to generate a first reference light beam and irradiates the first hologram with the first reference light beam to generate a first reproduction light beam including a recording pattern in a first reproduction mode;

a reproducing part which detects the first reproduction light beam to read the recording pattern contained in the first reproduction light beam and extract a particular incident angle for setting a second reference light beam from the recording pattern; and

a second optical system which applies a preset directionality to the light beam according to the particular incident angle to generate the second reference light beam in a second reproduction mode, the second reproducing optical system allowing the second reference light beam to enter the second hologram at the particular incident angle to generate a second reproduction light beam so that the reproducing part reproduces a reproduction signal.

According to another aspect of the present invention, there is provided an optical information recording apparatus comprising:

an optical recording medium having an optical recording layer in which a first hologram is formed by optical coaxial interference and in which a second hologram is formed by angle multiplexing interference in an area in which the first hologram is recorded;

a light source which generates a coherent light beam;

a first optical system which spatially separates the light beam to coaxially generate a first recording light beam having a recording pattern corresponding to first recording information which includes a particular incident angle, and a first reference light beam having a first reference pattern in a first recording mode, the first reproducing optical system allowing the first reference light beam and the first recording light beam to interfere with each other in the area to form the first hologram in the area; and

a second optical system which separates the light beam into a second reference light beam and a second recording light beam having a recording pattern corresponding to second recording information in a second recording mode, the second reproducing optical system allowing the second reference light beam to enter the area at the particular incident angle so that the second reference light beam and the second recording light beam interfere with each other to form the second hologram.

According to yet another aspect of the present invention, there is provided an optical information reproducing method comprising:

irradiating a first hologram formed on an optical recording medium by optical coaxial interference, with a first reference light beam containing a first reference pattern to generate a first reproduction light beam in a first reproduction mode;

detecting the first reproduction light beam to read a recording pattern and extract a particular incident angle for setting a second reference light beam from the recording pattern;

allowing the second reference light beam to enter a multiplicity of the second holograms formed in an area, in which the first hologram is formed, at the particular incident angle in the second reproduction mode to generate a second reproduction light beam; and

reproducing a reproduction signal from the second reproduction light beam to reproduce information.

According to further aspect of the present invention, there is provided an optical information recording and reproducing method comprising:

generating a first reference light beam and a first recording light beam having a recording pattern corresponding to first recording information in a first recording mode, the first recording information including a particular incident angle;

allowing the first reference light beam to enter an area of a recording medium at the particular incident angle so that the first reference light beam and the first recording light beam interfere with each other to form a first hologram in the area; and generating a second recording light beam having a recording pattern corresponding to the management data and a second reference light beam spatially separated from the second recording light beam in a second recording mod, and allowing the second reference light beam and the second recording light beam to interfere with each other to form a second hologram in the area to record the first and second hologram in the same area.

### BRIEF DESCRIPTION OF THE SEVERAL VIEWS OF THE DRAWING

FIG. 1 is a block diagram schematically showing a transmissive hologram optical recording and reproducing apparatus according to an embodiment of the present invention;

FIG. 2 is a block diagram schematically showing a reflective hologram optical recording and reproducing apparatus according to another embodiment of the present invention;

FIG. 3 is a cutaway sectional view schematically showing the structure of an optical recording medium shown in FIGS. 1 and 2;

FIG. 4 is a block diagram showing an optical system in the transmissive hologram optical recording and reproducing apparatus shown in FIG. 4;

FIG. 5 is a block diagram showing a transmissive angle multiplexing optical system in the hologram optical recording and reproducing apparatus shown in FIG. 1;

FIG. 6 is a plan view schematically showing a pattern displayed in a recording mode on a spatial light modulator located in a coaxial interfering optical system shown in FIGS. 1 and 2;

FIG. 7 is a plan view schematically showing a pattern displayed in a reproduction mode on the spatial light modulator located in the coaxial interfering optical system shown in FIGS. 1 and 2;

FIG. 8 is a block diagram showing a detection circuit in a focus and tracking servo optical system shown in FIGS. 1 and 2;

FIG. 9 is a plan view schematically showing a pattern displayed on a spatial light modulator in a transmissive angle multiplexing optical system shown in FIG. 5;

FIG. 10 is a block diagram schematically showing an optical path of a light beam in the reproduction mode in the transmissive angle multiplexing optical system shown in FIG. 5;

FIG. 11 is a block diagram schematically showing a reflective coaxial interfering optical system shown in FIG. 2;

FIG. 12 is a diagram showing the optical pulse waveforms of information light beams emitted, in the recording mode, to an optical recording medium shown in FIG. 3, according to a coaxial recording scheme and an angle multiplexing recording scheme, respectively;

FIG. 13 is a schematic diagram showing the operation of a tilt correcting mechanism shown in FIGS. 1 and 2;

FIG. 14 is a schematic diagram showing the operation of the tilt correcting mechanism shown in FIGS. 1 and 2;

FIG. 15 is a plan view showing the relationship between a beam spot formed on an optical recording medium shown in FIGS. 1 and 2 and a track;

FIG. 16 is a flowchart showing a recording operation of the hologram optical recording and reproducing apparatuses shown in FIGS. 1 and 2;

FIG. 17 is a flowchart showing a reproducing operation of the hologram optical recording and reproducing apparatuses shown in FIGS. 1 and 2; and

FIG. 18 is a graph showing a variation in the level of a signal from a target track and illustrating a tracking servo operation performed by the hologram optical recording and reproducing apparatuses shown in FIGS. 1 and 2, utilizing a reference light beam.

### DETAILED DESCRIPTION OF THE INVENTION

A hologram optical recording and reproducing apparatus according to an embodiment of the present invention will be described below with reference to the drawings.

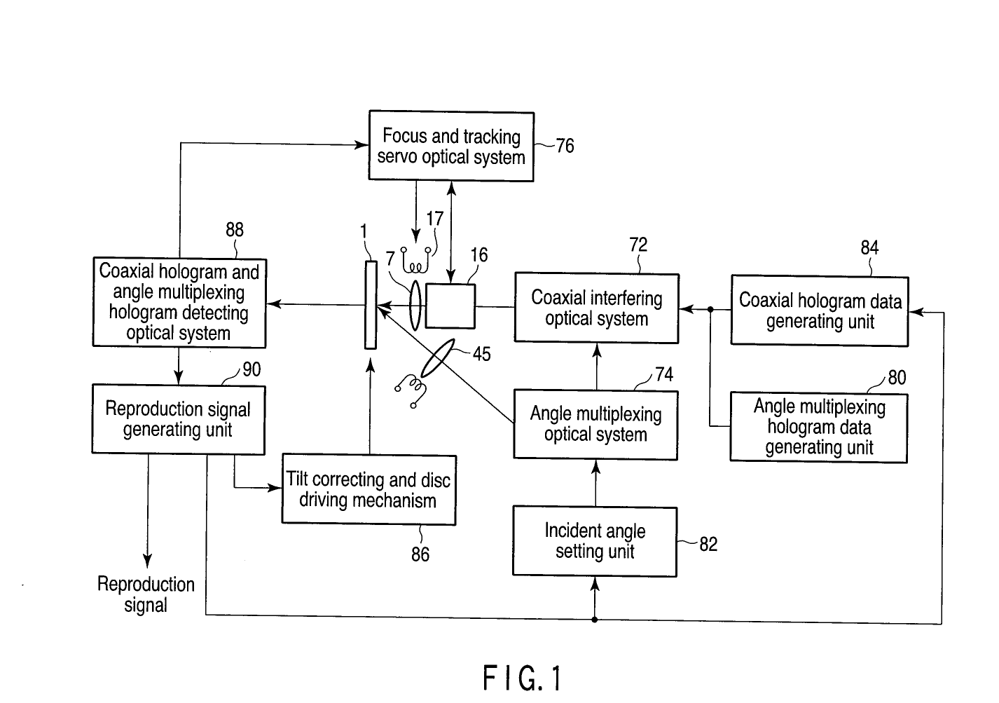

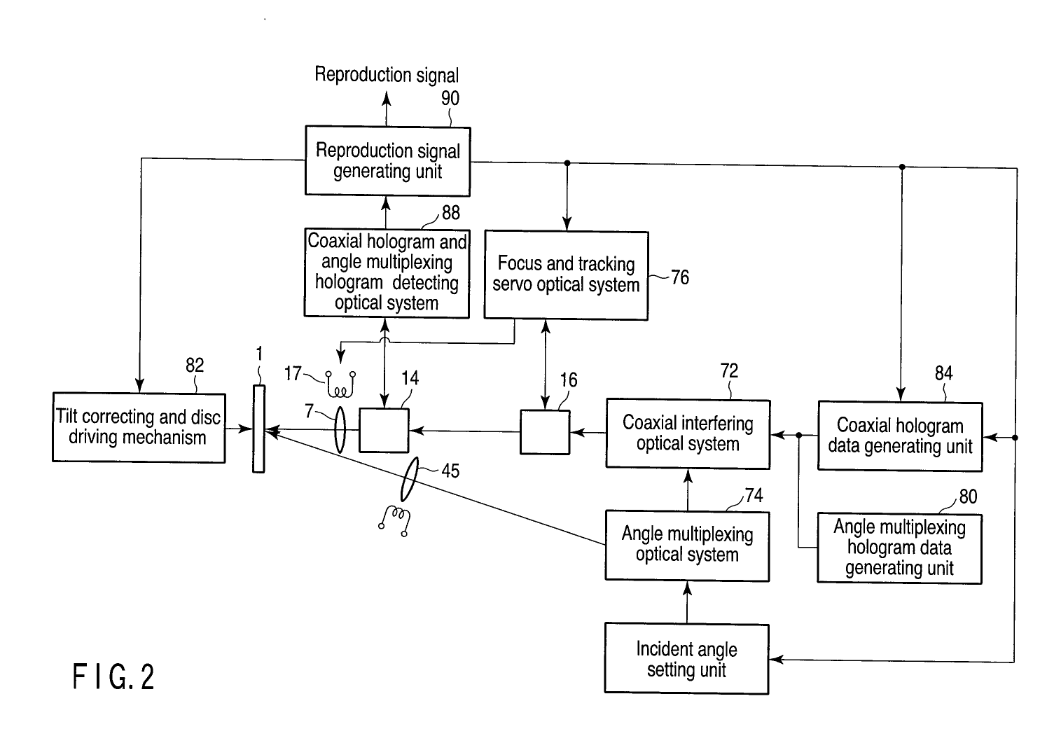

FIGS. 1 and 2 show hologram optical recording and reproducing apparatuses according to an embodiment and another embodiment, respectively, of the present invention. The apparatus shown in FIG. 1 has an arrangement of a transmissive optical system that detects an information light beam transmitted through an optical recording medium 1. FIG. 2 shows an arrangement of a reflective optical system that detects an information light beam reflected from the optical recording medium 1. In FIGS. 1 and 2, the same components are denoted by the same reference numerals, and duplicate descriptions are omitted.

In the transmissive optical system shown in FIG. 1, the optical recording medium 1 has a structure transparent to a light beam from a coaxial interfering optical system 72 and to a light beam from an angle multiplexing optical system 74. A focus and tracking servo optical system 76 detects a light beam returned from the optical recording medium 1 and thus the optical recording medium 1 has a reflection layer that selectively reflects a light beam from the servo optical system. If the focus and tracking servo optical system 76 detects the light beam transmitted through the optical recording medium 1, the optical recording medium 1 may have a structure transparent to all light beams.

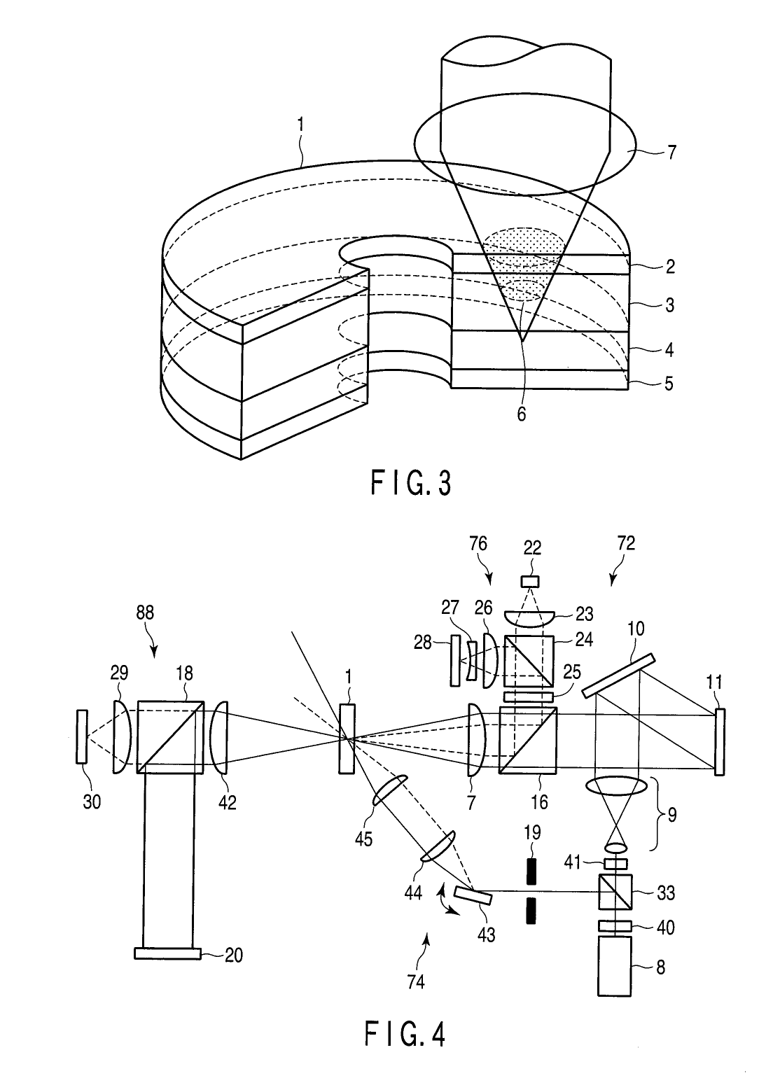

FIG. 3 shows the optical recording medium 1 formed like a disc and used for a transmissive coaxial interfering method. As shown in FIG. 3, the optical recording medium 1 has a transparent substrate 4 formed of glass, polycarbonate, or the like and comprising a recording layer 3 on one major surface of the transparent substrate 4 and a refection layer 5 on the other major surface which selectively reflects the light beam from the optical system. A protective layer 2 is provided on a light incident side of the recording layer 3. The protective layer 2 need not necessarily be provided on the optical recording medium.

The recording layer 3 is formed of a material such that when the light beam as an electromagnetic wave is emitted to the optical recording medium 1, the optical characteristics of the material vary depending on the intensity of the light beam. A hologram recording material used for the recording medium 3 may be organic or inorganic. Examples of the hologram recording material include a photopolymer, a photorefractive polymer, and a photo-chromic pigment distributing polymer. Examples of the inorganic hologram recording material include lithium niobate and barium titanate. The reflection layer 5 is formed of a material exhibiting a high reflectance at the wavelength of a recording light beam, for example, aluminum.

Although not shown in FIG. 3, information for tracking servo and address information are recorded on a surface of the transparent substrate 4 joined to the reflection layer 5, by using a structure having recesses and protrusions or the like. A preferable tracking servo scheme for the focus and tracking servo optical system 76 is a continuous servo scheme of continuously detecting tracking signals. However, if the recording light beam is irregularly reflected by the selective reflection layer 5, selectively reflecting light beams, to mix much noise into servo signals, a sampled servo scheme may be used which samples and holds the tracking signal. For the tracking servo information, for example, wobble pits may be provided in tracks (tracking guides) so that the tracking servo information can be reproduced from the wobble pits.

In the apparatus shown in FIG. 1, a servo light beam from the focus and tracking servo optical system 76 enters an objective lens 7 via an optical element such as a dichroic prism 16. The objective lens 7 directs the servo light beam to the reflection layer 5, which reflects and returns the servo light beam to the optical element such as the dichroic prism 16 via the objective lens 7. The servo light beam is then directed to the focus and tracking servo optical system 76 again. The focus and tracking servo optical system 76 detects the returned servo light beam to generate a focus error signal FE and a tracking error signal TE as described below in detail. The focus error signal FE and the tracking error signal TE drive an objective lens driving section including a voice coil motor 17 to maintain the objective lens 7 in a focus condition. The servo light beam searches for a target track to maintain the objective lens 7 in a tracking condition.

In the recording mode, first, data generated by a data generating unit 80 is provided to an angle multiplexing optical system 74 that directs a reference light beam to the recording layer 3 of the recording medium 1 via a relay lens 45. An information light beam having the same wavelength, phase, and polarizing surface as those of the reference light beam is guided through an optical path in the coaxial interfering optical system 72 and focused in the recording layer 3 in the recording medium 1. The information light beam contains an information pattern spatially modulated by the recording data generated by the angle multiplexing data generating unit 80. The information light beam and the reference light beam interfere with each other to generate a hologram. The incident angle at which the reference light beam enters the recording medium 1 is slightly increased or reduced (angle-multiplexed) to similarly form a hologram. The volume of one hologram recorded by the angle multiplexing is referred to as a book.

The incident angle for multiple recording is set by an incident angle setting unit 82. The incident angle and book address of a certain book are provided to a memory in a coaxial hologram data generating unit 84 as management information. When a large number of holograms are recorded in one book by the angle multiplexing scheme, the optical system is switched from the angle multiplexing optical system 74 to the coaxial interfering optical system 72 to record book information (management information) such as the address of the book, the number of the multiple holograms recorded by the angle multiplexing recording, and incident angle information on the reference light beam recorded by the angle multiplexing scheme. The coaxial interfering optical system generates an information light beam spatially modulated by the book information as well as a reference light beam and allows the information light beam and the reference light beam to interfere coaxially with each other to record the beams in the recording layer 3 in the recording medium 1.

In the reproduction mode, the reference light beam from the coaxial interfering optical system 72 is directed to the recording medium 1 via the objective lens 7. The reference light beam diffracted by a coaxial interfering hologram the recording layer 3 is introduced into a detecting optical system 88 as an information light beam. The detecting optical system 88 detects the information light beam. A reproduction signal generating unit 90 reproduces the book information, which is provided to the incident angle setting unit 82 and the like. The angle multiplexing optical system 74 is set for the incident angle contained in the book information so that the reference light beam is emitted by the angle multiplexing optical system 74 toward the angle multiplexing hologram in the recording layer 3. The angle multiplexing hologram similarly generates a diffracted light beam, which is transmitted to and detected by the detecting optical system as an information light beam. The information light beam is converted into a reproduction signal by the reproduction signal generating unit 90.

The recording medium 1 is rotationally driven by a driving mechanism 86. If the recording medium is tilted, the tilt is corrected by this tilt mechanism as described below.

The reflective optical system shown in FIG. 2 has almost the same configuration as that described above except that an optical element such as a polarizing beam splitter 14 is located between the objective lens 7 and the coaxial interfering optical system 72 to detect the information light beam reflected by the recording medium 1. Thus, the configuration of the reflective optical system will not be described below.

If the optical recording medium 1 shown in FIG. 3 is applied to the reflective coaxial interfering method, the recording layer 3 is formed on the major surface of the transparent substrate 4. The reflection layer 5 which reflects all the light beams is formed on the other major surface. The protective layer 2 is provided on the light incident side of the recording layer 3. The protective layer 2 need not necessarily be provided on the optical recording medium.

The objective lens 7 is located opposite the optical recording medium 1. A recording light beam emitted to the optical recording medium 1 through the objective lens 7 interferes with the reference light beam in the recording layer 3 to form a hologram 6 in the recording layer 3. Recording information is thus recorded in the recording layer 3 as a hologram.

In a recording and reproducing apparatus according to a reflective coaxial holography scheme, in the reproduction mode, the reference light beam is emitted to the recording medium 3 and diffracted by the hologram to generate a reproduction light beam (information light beam). The reference light beam emitted to the recording medium 3 is diffracted by the hologram and thus separated into a diffracted light component corresponding to the reproduction light beam (information light beam) and a remaining light component to be transmitted through the recording medium 3. The remaining transmission component may enter a photodetector together with the diffracted light component and reduce the SN ratio of the detection system. Thus, the detecting optical system is preferably based on a reflective polarizing coaxial interfering scheme of separating the light beam into the reference light beam and the reproduction light beam by means of polarization. The coaxial interfering optical system uses one spatial light modulator to generate an information light beam and a modulated reference light beam to record a hologram in the recording layer 3. The reference light beam is separated into the reference light beam and a reproduction light beam corresponding to a central portion and a peripheral portion, respectively, of an optical axis. The spatial light modulator can also be used for the angle multiplexing optical system, allowing the optical system to be made compact.

As is apparent from the description below, a transmissive recording and reproducing apparatus is more preferable than a reflective recording and reproducing apparatus because the former has the simplified optical system and allows the optical system to be easily aligned.

### [Coaxial Interfering Optical System 72 According to the Transmissive Coaxial Scheme]

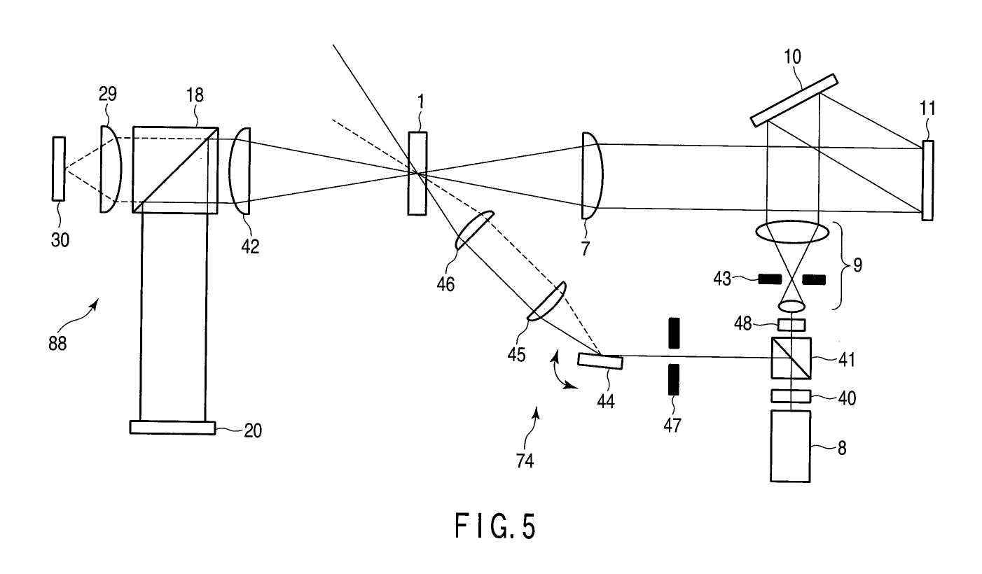

FIGS. 4 and 5 show an optical system of the transmissive recording and reproducing apparatus in detail. The coaxial interfering optical system 72 according to the transmissive coaxial scheme will be described with reference to FIG. 4.

This apparatuses uses the coaxial interfering method of using the single spatial light modulator 11 to generate an information light beam and a modulated reference light beam to record a hologram on the recording medium 1.

In the apparatus shown in FIGS. 4 and 5, a light source device 8 in the coaxial interfering optical system 72 is desirably a laser source that generates linearly polarized laser beams because light beams for the apparatus need to be coherent. Specific examples of the laser source include a semiconductor laser, a He—Ne laser, an argon laser, and a YAG laser. The light source device 8 preferably has a function of enabling the wavelength of emitted laser beams. A laser beam from the light source device 8 enters a beam expander 9, in which the laser beam is diffused (diverged) and shaped (collimated) into a parallel luminous flux. The collimated laser beam is reflected by a mirror 10 and then impinges on the reflective spatial light modulator 11.

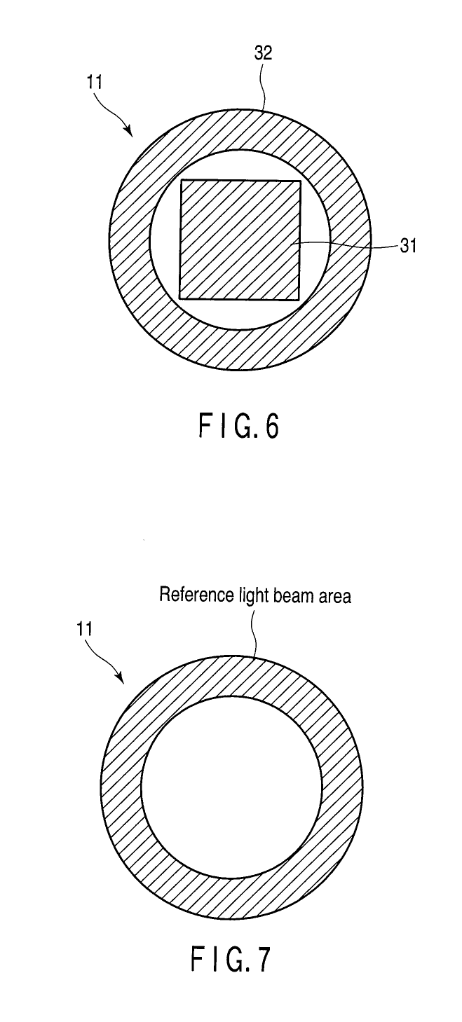

The reflective spatial light modulator 11 has a plurality of pixels two-dimensionally arranged like a lattice, and has a polarizing element structure that can vary the direction of the reflected luminous flux for each pixel or a polarizing optical element that can vary the polarizing direction of the reflected flux for each pixel. A laser beam entering the light modulator 11 configured as described above is spatially modulated when reflected by the modulator 11. The laser beam is thus separated into an information light beam provided with information as a two-dimensional pattern and a reference light beam. The information light beam and the reference light beam are directed to an image forming optical system made up of image forming lenses 12, 13. That is, the reflective spatial light modulator 11 simultaneously generates, from the single laser beam, the information light beam and reference light beam coaxially directed to the image forming optical system. The reflective spatial light modulator 11 may be a digital mirror device (DMD), a reflective liquid crystal element, a reflective modulating element using a magneto-optical effect, or the like. The reflective spatial light modulator 11 shown in FIGS. 4 and 5 is assumed to be the digital mirror device (DMD). Such a modulation pattern as shown in FIG. 6 is displayed on the reflective spatial light modulator 11. That is, a reflection surface of the light modulator 11 has a central area including an optical axis and defined as an information light beam area 31, and a peripheral area of the central area defined as a reference beam area 32 that generates the reference light beam.

In the recording mode, the reflective spatial light modulator 11 generates a recording light beam containing an information light beam and a reference light beam which are coaxially transmitted. The generated recording light beam enters the polarizing beam splitter 14 via an image forming lens made up of image forming lenses 12 and 13. Here, the recording light beam has such a polarization plane as allows the recording light beams to pass through the polarizing beam splitter 14. That is, a laser beam emitted by the light source device 8 is polarized in a particular direction or passes through the polarizing element before being polarized in the particular direction. The recording light beam transmitted through the polarizing beam splitter 14 passes through an optical rotary element 15 that rotates the polarization plane of the recording light beam. The recording light beam then enters the dichroic prism 16. The dichroic prism 16 has a dichroic mirror that allows the wavelength of the recording light beam to pass through. The recording light beam transmitted through the dichroic prism 16 is emitted to the optical recording medium 1 by the objective lens 7. The objective lens 7 has its focus adjusted by the voice coil motor 17 so as to be maintained in a focus condition. In the focus condition, the emitted recording light beam is focused so as to minimize the diameter of the beam on a surface of the reflection layer 5 of the optical recording medium 1. A quarter wavelength plate, a half wavelength plate, or the like is used as the optical rotary element 15.

On the optical path, the information light beam is propagated through the central area including the optical axis, and the reference light beam is propagated through the peripheral portion of the central area. The recording light beam, containing the information light beam and the reference light beam, is emitted to the optical recording medium 1. The information light beam and the reference light beam interfere with each other inside the recording layer to form the hologram 6 on the optical recording medium 1.

When the pattern of the reference light beam is specified for each tracking guide and one tracking guide is specified, the pattern of the reference light beam is changed on the basis of the specification.

In the reproduction mode, in which recorded information is reproduced, as in the case of the recording mode, a laser beam from the laser source 8 is directed to the reflective spatial light modulator 11, which reflects the reference light beam. In the reproduction mode, as shown in FIG. 7, such a pattern as allows only the reference light beam to be reflected to the recording medium 1 by the reflective spatial light modulator 11 is formed on the reflection surface of the reflective spatial light modulator 11. The pattern has the same modulation pattern as that formed in the reference light beam area of the recording light beam, corresponding to the peripheral portion, when the recording light beam shown in FIG. 6 is generated. The reflective spatial light modulator 11 reflects the reference light beam to the optical recording medium 1 as in the case of the recording mode. As is apparent from a comparison of FIG. 6 with FIG. 7, the central area of the reflective spatial light modulator 11, which generates the information light beam, is controlled so as to generate such a pattern as avoids reflecting the light beam to the optical recording medium 1. Obviously, in the reproduction mode, the reference light beam is directed to the optical recording medium 1 through an optical path similar to that for the recording light beam.

The reference light beam enters the optical recording medium 1 and then the hologram 6 formed on the recording layer 3. A fraction of the reference light beam is diffracted by the hologram 6 to generate a reproduction light beam. The reproduction light beam is directed to a collimator lens 42 through the reflection layer 5 in the optical recording medium 1 and then reflected to a two-dimensional photodetector 20 by a dichroic prism 18. Consequently, the reproduction light beam is formed into a reproduction image on the two-dimensional photodetector 20 by the collimator lens 42. The reproduction image corresponds to a pattern formed in the information light beam area 31 of the reflective spatial light modulator 11 in the recording mode. Formation of the reproduction image allows the information contained in the hologram to be reproduced. A fraction of the reference light beam not diffracted by the hologram 6 is formed into a transmission light beam on the two-dimensional photodetector 20 as is the case with the reproduction light beam. On the two-dimensional photodetector 20, the reproduction image pattern of the reproduction light beam is formed in the central area, and the irradiation pattern of the transmission light beam is formed in the peripheral portion. The reproduction image pattern on the central area and the irradiation pattern on the peripheral portion are separately formed on the two-dimensional photodetector 20. Thus, the reproduction image pattern alone is easily spatially separated from the irradiation pattern. A reproduction signal is reproduced from the reproduction image pattern.

### [Focus and Tracking Servo Optical System 76]

Now, tracking servo and focus servo in the apparatus shown in FIG. 4 will be described.

As shown in FIG. 4, the optical recording and reproducing apparatus has a servo light source device 22 that generates servo light beams. The light source device 22 is desirably a laser source that generates linearly polarized laser beams. Specific examples of the laser source include a semiconductor laser, an He—Ne laser, an argon laser, and a YAG laser. The laser source desirably generates laser beams with a wavelength which is different from that for the recording light source device 8 and which avoids changing the optical characteristics of the recording layer 3. By way of example, the light source device 22 is most desirably a semiconductor laser that generates red laser beams of wavelength about 650 nm. A servo light beam emitted by the light source device 22 is shaped (collimated) into a parallel luminous flux by a collimate lens 23. The parallel luminous flux then enters a polarizing beam splitter 24. Here, the servo light beam emitted by the light source device has a polarization plane having such a polarizing direction as allows the servo light beams to pass through the polarizing beam splitter 24. The servo light beam transmitted through the polarizing beam splitter 24 passes through an optical rotary element 25 and then enters the dichroic prism 16. The dichroic prism 16 has such a dichroic mirror as reflects the wavelength of the servo light beam. As is the case with the optical element 15, a quarter wavelength plate, a half wavelength plate, or the like is used as the optical rotary element 25. The servo light beam reflected by the dichroic prism 16 is emitted to the optical recording medium 1 by the objective lens 7. The servo light beam is focused so as to minimize the diameter of the beam on the surface of the reflection layer 5 of the optical recording medium 1. The servo light beam is selectively reflected by the reflection layer 5, and upon the reflection, modulated by pits formed on the reflection surface 5. The servo return light beam reflected by the optical recording medium 1 passes through the objective lens 7 and enters the dichroic prism 16. The light beam is reflected by the dichroic prism 16 at an interface of the prism 16 and passes through the rotary optical element 25. The light beam is then directed to the polarizing beam splitter 24. Moreover, when the servo return light beam passes through the rotary optical element 25, the polarization plane of the servo return light is rotated to convert the light beam into a polarized beam containing a polarization component different from those of the servo light beam emitted by the light source device 22. The polarized beam is then reflected by the polarizing beam splitter 24.

The orientation angle of the rotary optical element 25 is desirably adjusted such that the polarization plane of the servo return light beam is rotated by the rotary optical element 25 so as to maximize the reflectance at which the servo return light beam is reflected by the polarizing beam splitter 24.

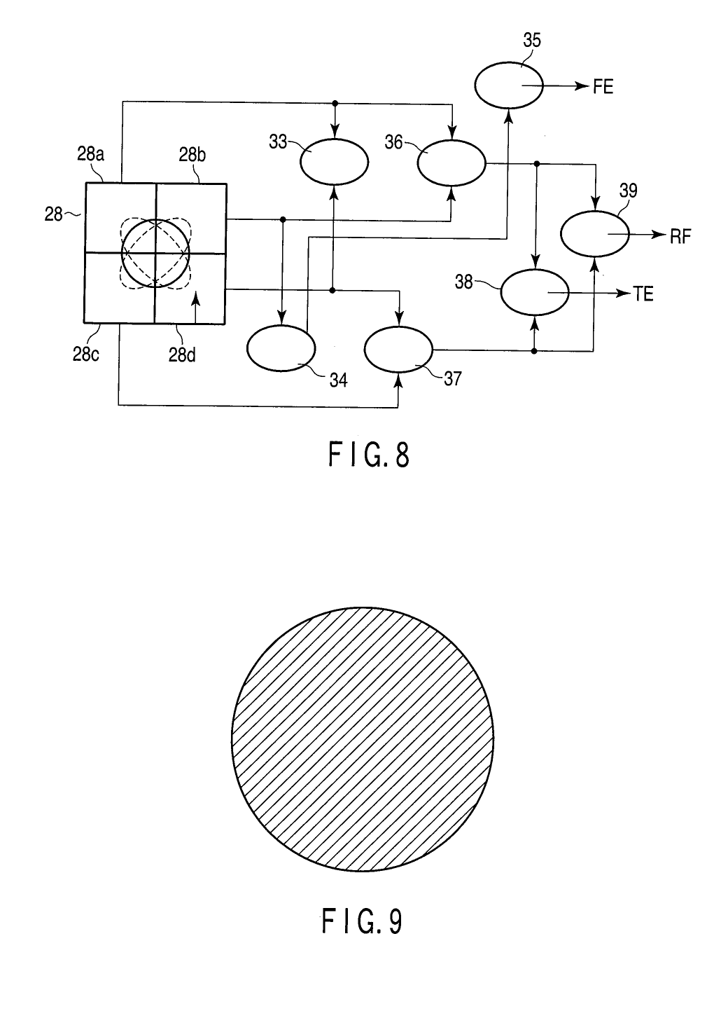

The servo return light beam reflected by the polarizing beam splitter 24 is directed to a four-division photodetector 28 through an astigmatism optical system composed of a convex lens 26 and a cylindrical lens 27. The four-division photodetector 28 detects the servo return light beam. On the basis of a detection signal from the four-division photodetector, a reproduction signal RF, a focus error signal FE, and a tracking error signal TR each containing an address signal, as shown in FIG. 8.

FIG. 8 shows a circuit that detects the focus error signal FE and the tracking error signal TE on the basis of the output from the four-division photodetector 28. This detection circuit is composed of an adder 33 that adds together outputs from light receiving sections 28a and 28d diagonally arranged in the four-division photodetector 28, an adder 34 that adds together outputs from light receiving sections 28b and 28c diagonally arranged in the four-division photodetector 28, and a subtractor 35 that calculates the difference between an output from the adder 33 and an output from the adder 34 to generate the focus error signal FE based on an astigmatism method. The detection circuit shown in FIG. 8 comprises an adder 36 that adds together the outputs from the light receiving sections 28a and 28b, arranged adjacent to each other in a track direction of the four-division photodetector, an adder 37 that adds together the outputs from the light receiving sections 28c and 28d, arranged adjacent to each other in the track direction of the four-division photodetector, a subtractor 38 that calculates the difference between the outputs from the adders 36 and 37 to generate the tracking error signal TE based on a push pull method, and an adder 39 that adds outputs from the adders 36 and 37 together to generate the reproduction signal RF.

The reproduction signal RF corresponds to a signal obtained by reproducing information prerecorded on the reflection layer 5 in the optical recording medium 1. The misalignment between the optical recording and reproducing apparatus and the optical recording medium is corrected (focus correction and tracking correction) by energizing the voice coil motor 17, shown in FIG. 2, to drive the objective lens 19 so as to zero each of the focus error signal FE and the tracking error signal TE obtained from the four-division photodetector 28 as described above. The focus servo and tracking servo utilizing the astigmatism method is well known and will thus not be described further.

### [Transmissive Angle Multiplexing Optical System 74]

The recording and reproducing apparatus according to the transmissive angle multiplexing scheme will be described with reference to FIGS. 4, 5, 9, and 10.

The recording medium 1 on and from which information is recorded and reproduced by the recording and reproducing apparatus according to the transmissive angle multiplexing scheme has a structure substantially similar to that of the recording medium 1 according to the reflective coaxial scheme as already described with reference to FIG. 1. The recording medium 1 has the reflection layer 5 that selectively reflects only servo light beams, and is transparent so as to detect transmitted light beams.

Like the light source device according to the reflective coaxial scheme, the light source device 8 is desirably a laser source that generates coherent laser beams. A light beam emitted by the light source device 8 passes through a λ/2 wavelength plate 40 and is then divided into two light beams by a polarizing beam splitter 41. The λ/2 wavelength plate 40, which rotates the polarization plane of light beams, can adjust the ratio of the intensities of the two light beams into which the light beam from the light source device 8 is divided so as to adjust the orientations of the resulting two beams. The light beam transmitted through the polarizing beam splitter 41 enters a wavelength plate 48 again, where the polarization plane of the light beam is rotationally adjusted so as to be the same as that of the other light beam reflected by the polarizing beam splitter 41. The light beam emitted by the wavelength plate 48 is diffused (diverged) by the beam expander and thus shaped (collimated) into a parallel luminous flux. The luminous flux is then emitted to the spatial light modulator 11.

A pattern different from that on the coaxial modulator 11 shown in FIG. 6 is displayed on the spatial light modulator 11, for example, a uniform pattern of two-dimensional data (information light beam pattern) shown in FIG. 9. The light beam reflected by the spatial light modulator and having information is emitted to the recording medium 1 through the lens 7. This light beam is referred to as the information light beam. The other light beam reflected by the polarizing beam splitter 4 is reflected by a galvano mirror 44 and then emitted to the recording medium 1 through lenses 45 and 46 constituting a projection lens system. This light beam is referred to as the reference light beam. For the reference light beam, a reference beam incident point on the galvano mirror 44 and a reference light beam irradiation point (focusing point) in the recording medium 1 are arranged conjugate to the lenses 45 and 46 so that the reference light beam is always emitted to the same point on the recording medium 1 even if the galvano mirror 44 is slightly rotated. The optical system is located such that the focusing point of the information light beam aligns with the focusing point of the reference light beam, in the recording layer 3 in the recording medium 1.

In the recording mode, the information light beam and the reference light beam overlap in the recording layer 3 in the recording medium 1. Interference fringes are thus created which reflect conditions for the recording mode such as the incident angles, wavefronts, wavelengths, and the like of the reference light beam and the information light beam containing the information pattern displayed on the spatial light modulator 11. As a result, a hologram is formed on the recording layer 3 in the recording medium 1.

After contributing to the generation of the hologram, the information light beam is directed to the collimator lens 42 through the recording medium 1. The information light beam is collimated by the beam splitter 18 and formed into an image on the detection surface of the image sensor 20. The reproduction beam transmitted through the beam splitter 18 is focused and directed to the photodetector 30 by a projection lens 29. The photodetector 30 monitors the intensity of the information light beam.

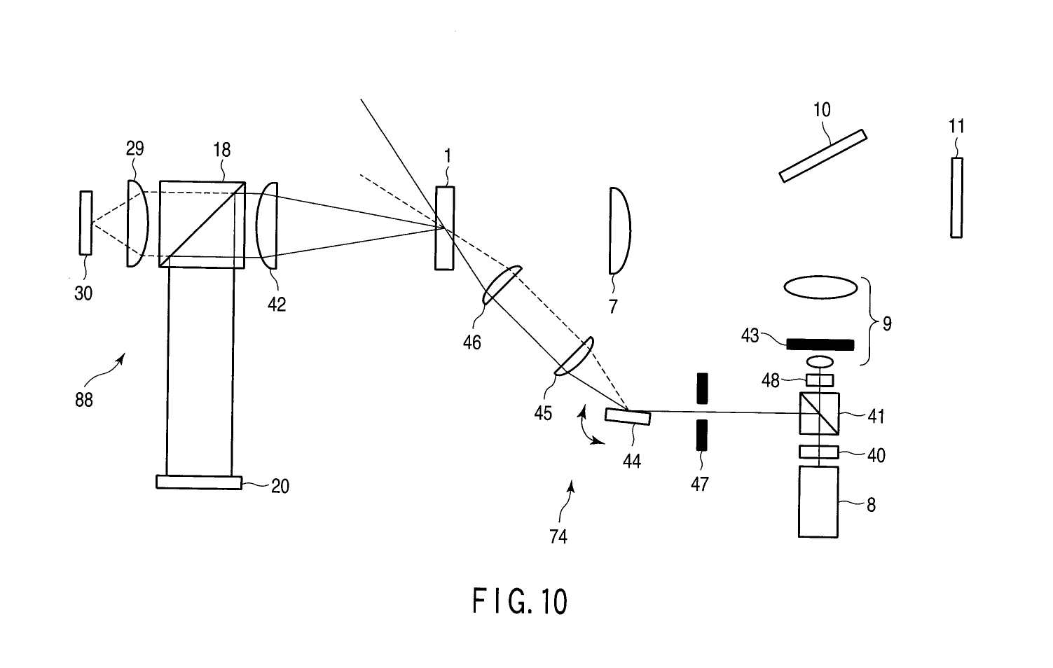

In the reproduction mode, as shown in FIG. 10, only the reference light beam is directed to the recording medium 1, and control is performed so as to avoid generating the information light beam. In the optical system shown in FIG. 10, for example, a shutter 43 is provided between the polarizing beam splitter 41 and the modulator 11 as an optical path blocking member. The shutter 43 is closed to block the optical path. When the reference light beam under the same conditions as those under which the reference light beam is emitted in the recording mode enters the recording medium 1 via the galvano mirror 44 and the lenses 45 and 46, interference fringes recorded on the recording medium 1 diffracts the reference light beam. The diffracted light beam enters the collimator lens 42 as a reproduction light beam. Here, the same conditions mean that the reference light beam under the same conditions as those under which the reference light beam is emitted in the information recording mode, that is, the reference light beam with the same wavelength, wavefront, and incident angle, is directed to the galvano mirror 44. The reproduction light beam is collimated by the collimator lens 42 and then enters the beam splitter 18. The reproduction light beam is then reflected by the beam splitter 18 and formed into an image on the detection surface of the image sensor 20. The reproduction beam transmitted through the beam splitter 18 is focused and directed to the photodetector 30 by the projection lens 29. The photodetector 30 monitors the intensity of the reproduction light beam.

In the recording medium 1, diffraction occurs only when black conditions are met. Diffraction is not caused by the entry of the reference light beam under conditions different from those under which the reference light beam is emitted in the recording mode. In this case, no information is obtained. For example, the obtainment of the diffracted light is prevented by, for example, irradiating the recording medium with the reference light beam while rotating the galvano mirror 44 to make the incident angle of the reference light beam slightly different from that for the recording mode.

### [Coaxial Interfering Optical System 72 According to the Reflective Coaxial Scheme]

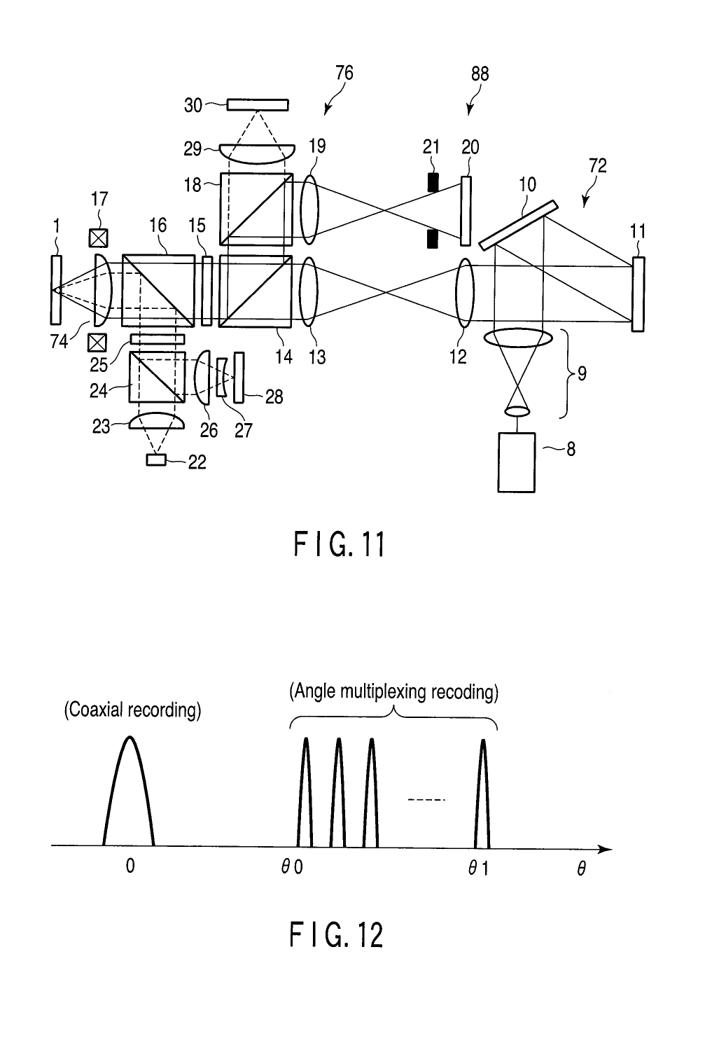

FIG. 11 shows the coaxial interfering optical system 72 according to the reflective coaxial scheme.

As is the case with the transmissive coaxial scheme, the apparatus shown in FIG. 11 uses the single spatial light modulator 11 to generate an information light beam and a modulated reference light beam to record a hologram on the recording medium 1. In the recording mode, an optical system and a hologram recording method are the same as those for the coaxial interfering optical system 72 according to the transmissive coaxial scheme. Thus, see the description of the coaxial interfering optical system 72 according to the transmissive coaxial scheme.

In the reproduction mode, in which recorded information is reproduced, a laser beam from the laser source 8 is directed to the reflective spatial light modulator 11, which reflects a reference light beam. In the reproduction mode, as shown in FIG. 7, such a pattern as allows only the reference light beam to be reflected to the recording medium 1 by the reflective spatial light modulator 11 is formed on the reflection surface of the reflective spatial light modulator 11. The pattern has the same modulation pattern as that formed in the reference light beam area of the recording light beam, corresponding to the peripheral portion, when the recording light beam shown in FIG. 6 is generated. The reflective spatial light modulator 11 reflects the reference light beam to the optical recording medium 1 as in the case of the recording mode. Obviously, in the reproduction mode, the reference light beam is directed to the optical recording medium 1 through an optical path similar to that for the recording light beam.

The reference light beam enters the optical recording medium 1 and then the hologram 6 formed on the recording layer 3. A fraction of the reference light beam is diffracted by the hologram 6 to generate a reproduction light beam. The reproduction light beam is reflected to the objective lens 7 again by the reflection layer 5 in the optical recording medium 1. The reproduction light beam enters the rotary optical element 15 through the dichroic prism 16. When the reproduction light beam passes through the rotary optical element 15, the polarization plane of the reproduction light beam is rotated to convert the light beam into a polarized beam containing a polarization component different from those of the reference light beam. Consequently, the reproduction light beam is reflected to the detecting optical system by the polarizing beam splitter 14.

The orientation angle of the rotary optical element 15 is desirably adjusted such that the polarization plane of the reproduction light beam is rotated by the rotary optical element 15 so as to maximize the reflectance at which the reproduction light beam is reflected by the polarizing beam splitter 14. Almost all of the reproduction light beam reflected by the polarizing beam splitter 14 is reflected to the image forming lens 19 in the detecting optical system by the beam splitter 18. The reproduction light beam is formed into a reproduction image on the two-dimensional photodetector 20 by the image forming lens 19. The reproduction image corresponds to a pattern formed in the information light beam area 31 of the reflective spatial light modulator 11 in the recording mode. Formation of the reproduction image allows the information contained in the hologram to be reproduced. A fraction of the reference light beam not diffracted by the hologram 6 is formed into a transmission light beam on the two-dimensional photodetector 20 as is the case with the reproduction light beam. On the two-dimensional photodetector 20, the reproduction image pattern of the reproduction light beam is formed in the central area, and the irradiation pattern of the transmission light beam is formed in the peripheral portion. The reproduction image pattern on the central area and the irradiation pattern on the peripheral portion are separately formed on the two-dimensional photodetector 20. Thus, the reproduction image pattern alone is easily spatially separated from the irradiation pattern. A reproduction signal is reproduced from the reproduction image pattern.

To maintain an acceptable SN ratio for reproduction signals, an iris may be placed between the photodetector 20 and the image forming lens 19 to block the reference light beam.

### [Focus and Tracking Servo Optical System 76 According to the Reflective Coaxial Scheme]

The focus and tracking servo optical system 76 according to the reflective coaxial scheme is the same as the transmissive focus and tracking servo optical system 76. See the above description of the focus and tracking servo optical system 76.

### [Reflective Angle Multiplexing Optical System 74]

The reflective angle multiplexing optical system 74 has substantially the same optical system as that of the transmissive angle multiplexing optical system 74 and will not be described below. Thus, for the recording mode, see the description of the transmissive angle multiplexing optical system 74.

In the reproduction mode, in an optical system shown in FIG. 11, only the reference light beam is directed to the recording medium 1. When the reference light beam under the same conditions as those under which the reference light beam is emitted in the recording mode enters the recording medium 1, the interference fringes recorded in the recording medium diffracts the reference light beam. The diffracted light beam is then returned to the objective lens 7 as a reproduction light beam. The reproduction light beam is returned to the polarizing beam splitter 14 via the objective lens 7, the dichroic prism 16, and the wavelength plate 15, and reflected by the polarizing beam splitter 14. The reflected reproduction light beam is reflected by the beam splitter 18 and formed into an image on the detection surface of the image sensor 20. The reproduction beam transmitted through the beam splitter 18 is focused and directed to the photodetector 30 by the projection lens 29. The photodetector 30 monitors the intensity of the reproduction light beam.

### [Differences Between the Coaxial Scheme and the Angle Multiplexing Scheme]

The differences between the coaxial scheme and the angle multiplexing scheme will be described below.

The coaxial scheme and the angle multiplexing scheme differ from each other in a multiplexing method. The coaxial scheme records information by shift multiplexing in which the coaxial reference light beam and information light beam are shifted from each other to displace beam spots from each other. That is, when the recording medium 1 or the optical system is shifted parallel to the surface of the recording medium 1, the difference between the phase of diffracted light generated on a closer side in the shift direction and that generated on a farther side in the shift direction is exactly reversed, eliminating the diffracted light. This shift selectivity is utilized to record multiple pieces of information. If the light beam has a circular cross section, the level of the shift selectivity increases consistently with the diameter of the reference light beam and with the width of the reference light beam pattern. The increased level of the shift selectively allows more information to be recorded but limits the size of the beam. The increased width of the reference light beam pattern reduces the area of the information light beam, preventing an increase in write capacity. That is, there is a tradeoff between the shift selectivity and the reference light beam.

As the name suggests, the angle multiplexing scheme uses angle selectivity for multiple recording. In the optical system shown in FIG. 5, even with slight rotation of the galvano mirror 44, the area in which the resulting recording spot is formed is not changed. Multiple pieces of information are recorded in the same volume with only the incident angle of the reference light beam changed. The volume of one hologram recorded by angle multiplexing is called a book.

As shown in FIG. 12, in the recording layer in the recording medium 1, an information light beam with an incident angle 0 (θ=0) is emitted by pulse to form a book in the same volume. According to the angle multiplexing scheme, the information light beam is emitted by pulse with the incident angle (θ=θ0, . . . , θ0) slightly increased and reduced, to form a book in the same volume.

### [Tilt Correcting Mechanism 86]

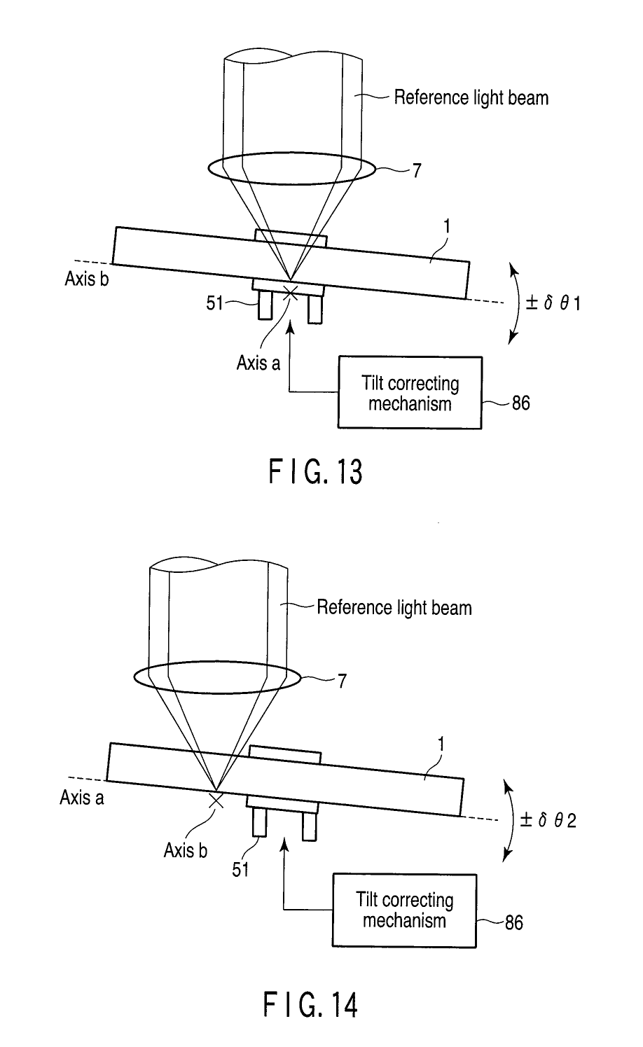

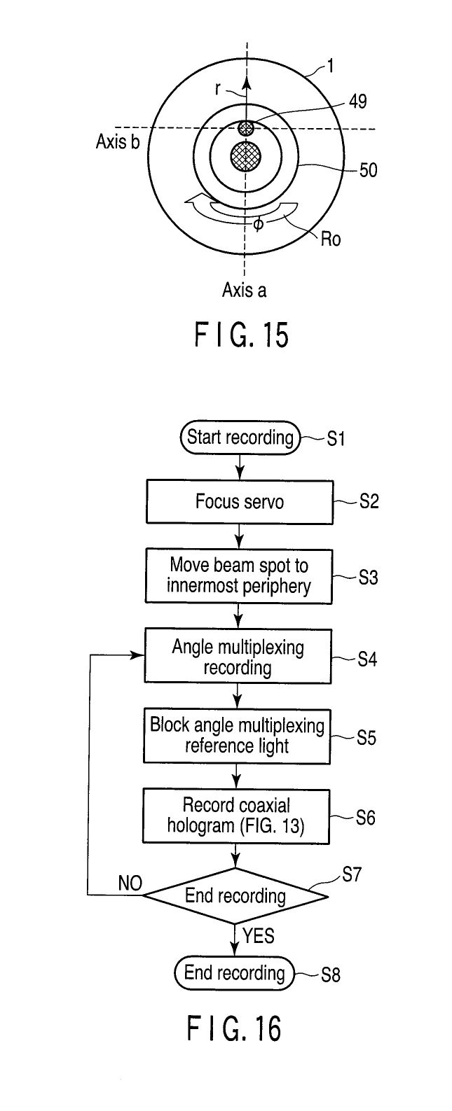

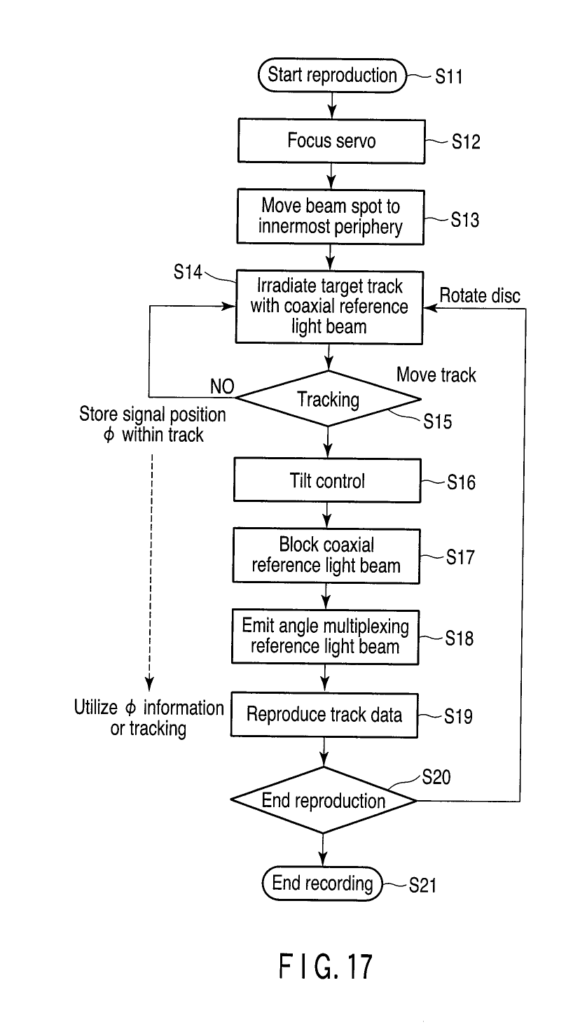

With reference to FIGS. 13 and 14, the operation of the tilt correcting mechanism 86 will be described. As shown in FIG. 13, if an axis (b) is inclined at a tilt angle δ to a plane orthogonal to the optical axis of the reference light beam, the optical recording medium 1 is slightly moved around the axis a. For example, as shown in FIG. 17, the tilt correcting mechanism 86 operates to unevenly move a projecting portion 51 up and down which is provided in a rotational driving section contacting the recording medium 1, so as to correct the tilt angle δ. The recording medium 1 is thus tilted within the range of slight tilt amount from +δƒ1 to −δθ1. The light intensity of the reproduction light beam is correspondingly varied, so that the reproduction light beam is detected. The tilt correcting mechanism 86 sets the recording medium 1 at the optimum slight tilt angle so as to maximize the signal intensity resulting from the reproduction light beam. The tilt angle δ is thus corrected. Once the optimum slight tilt angle is specified, the recording medium 1 is rotated while being maintained at the optimum slight tilt angle. The tilt correcting mechanism 86 always monitors the reproduction light beam signal and controllably sets the recording medium 1 at a certain tilt angle so as to maximize the value for the reproduction light beam signal.

Similarly, if the axis (a) is inclined at the tilt angle δ to the plane orthogonal to the optical axis of the reference light beam as shown in FIG. 14, the optical recording medium 1 is slightly moved around the axis b. That is, the tilt correcting mechanism 86 operates to unevenly move the projecting portion 51 up and down which is provided in a rotational driving section contacting the recording medium 1, so as to correct the tilt angle δ. The recording medium 1 is thus tilted within the range of slight tilt amount from +δθ1 to −δθ1. In conjunction of the tilt of the recording medium 1 within the range of slight tilt amount from +δθ1 to −δθ1, the light intensity of the reproduction light beam is varied. Thus, the reproduction light beam is detected. The tilt correcting mechanism 86 sets the recording medium 1 at the optimum slight tilt angle so as to maximize the signal intensity resulting from the reproduction light beam. The tilt angle δ is thus corrected. Once the optimum slight tilt angle is specified, the recording medium 1 is rotated while being maintained at the optimum slight tilt angle. The tilt correcting mechanism 86 always monitors the reproduction light beam signal and controllably sets the recording medium 1 at a certain tilt angle so as to maximize the value for the reproduction light beam signal.

In this case, the axis (a) corresponds to an axis passing through the optical axis extending along a radial direction (r) as well as a beam spot 49 as shown in FIG. 15. The axis (b) corresponds to a straight line crossing the axis (a) at right angles and passing through the beam spot 49, the straight line being parallel to the surface of the recording medium 1. The tilt angle δ at which the beam spot aligns with a target track is preferably recorded in the hologram recorded by coaxial interfering recording as described above, as management information together with information specifying the disc and information specifying the recording medium 1 and the number of the track 50.

### [Recording Position of the Book]

As shown in FIG. 15, the position of the book recorded by the beam spot 49 is preferably is specified by measuring a rotation angle φ through which the signal in the track 50 has the maximum value. The rotation angle φ corresponds to a rotation angle from a reference position in the track 50 and indicating the recording position of the book recorded in the track 50. The rotation angle φ is preferably recorded in the hologram recorded by coaxial interfering recording, in the same track or another track.

When the information recorded in the target track is reproduced according to the angle multiplexing scheme, the following operation is desirably repeated to increase transfer speed: with the incident angle of the reference light beam fixed, the recording medium 1 is rotated in the direction φ to reproduce the track, and with the incident angle of the reference light beam changed, the track is reproduced again. For the information light beam detected by the image sensor 20, the vicinity of a fraction of the light beam with the highest diffraction intensity is desirably efficiently detected.

The image sensor 20 detects only a fraction of the information light beam obtained in the vicinity of the angle φ of the maximum value measured when the coaxial reference light beam is emitted to the recording medium. The data contained in the detection signal is decoded, allowing information on reproduction conditions contained in the hologram to be obtained. The coaxial scheme offers a high shift selectivity (a low angle dependence) to allow the book position to be accurately detected. The position selectivity of the coaxial scheme hologram depends on the area of the coaxial reference light beam. The increased area of the coaxial reference light beam improves the position selectivity. On the other hand, the area of the coaxial information light beam decreases to reduce the amount of expressible information. However, as described above, the coaxial scheme hologram is used to record only supplementary information such as management information. Thus, the area of the coaxial information light beam need not be so large compared to the area of the coaxial reference light beam. The area of the coaxial reference light beam can advantageously be freely set so as to offer a sufficient position selectivity. This enables angle multiplexing information light beams to be accurately reproduced from recording positions with higher diffraction intensities, and also increases a transfer rate. When the track 50 is moved, the reference light beam is blocked by the shutter 47, and the reference light beam for the target track according to the coaxial scheme is emitted. Then, the track is detected, the angle φ through which the book is recorded is detected, and the information light beam is reproduced.

According to a scheme, as a comparative example, of recording information using a unitary optical system based on the transmissive angle multiplexing scheme, the optical axis of the reference light beam is mechanically controlled depending on mechanical accuracy to align the beam spot with the book to be reproduced. The mechanical control is expected to allow reproduction to be achieved to some degree with the same drive and the same recording medium (disc), in spite of reduced efficiency. However, with different drives and different recording media (discs), allowing the beam spot to reach the target book is difficult. However, as described above, the beam spot is aligned with the target book with the position selectivity accuracy of the coaxial scheme hologram, and the reproduction conditions according to the angle multiplexing scheme is efficiently pre-reproduced. This facilitates the reproduction according to the angle multiplexing scheme, and allows reproduction signals to be accurately reproduced from the book according to the angle multiplexing scheme.

### [Angle Selectivity and Shift Selectivity]

Now, the angle selectivity and shift selectivity of the angle multiplexing scheme and the coaxial scheme will be described with reference to formulae described below.

Formula 1 expresses a diffraction efficiency η(θ,L,Δθ).

$$η ( θ , L , Δθ ) = {( \frac{π nL}{λ cos ( θ )} )}^{2} sin {c ( \frac{2 nL sin ( θ )}{λ} Δθ )}^{2} \qquad ( 1 )$$

In Formula 1, L denotes the thickness of the recording medium, λ denotes a laser wavelength, θ denotes the difference in incident angle between the information light beam and the reference light beam, n denotes the refractive index of the recording medium, and Δθ denotes the angle selectivity.

As is easily understood from Formula 1, the angle selectivity of diffraction efficiency increases consistently with the thickness of the recording medium 1 and the difference θ. Specifically, when L=200 μm, n=1.5, and θ=45°, the angle selectivity is about 0.2°. When L=1.0 mm, the angle selectivity is about 0.03°. This means that even at this level, a variation in the incident angle of the reference light beam prevents diffracted light from being obtained.

In contract, according to the coaxial scheme, the angle θ depends on NA of the lens 7. For example, when NA=0.6 and n=1.5, the maximum angle difference θ is 24°. The angle selectivity is 0.06°. However, according to the coaxial scheme, since the maximum angle difference θ is 24° and smaller angles are available, the angle selectivity can be further reduced. Furthermore, to increase interference efficiency, spatial light modulation is performed to further reduce the difference in incident angle between the light beams and the angle selectivity; the angle selectivity decreases by a factor of several to ten. That is, the diffraction angle margin according to the coaxial scheme is several-fold to tenfold larger. Conversely, the shift selectivity is lower according to the angle multiplexing scheme and is about several tens of μm depending on the diameter of the reference light beam. In contrast, according to the coaxial scheme, the shift selectivity is at most 10 μm.

Formula 2 indicates the diffraction efficiency η(θ,L,Δθ) and uses, as variables, the difference Δn in refractive index in the recording medium in addition to λ, L, and θ.

$$η ( θ , L , Δθ ) ∝ {sin}^{2} ( \frac{πΔ nL}{λ cos θ} ) \qquad ( 2 )$$

To obtain the same diffraction efficiency η(θ,L,Δθ), the coaxial scheme, involving a small incident angle difference θ, requires a larger diffraction rate difference Δn for the recording medium. That is, setting a large diffraction rate difference Δn causes the volume recorded in the recording medium to be consumed. Thus, the angle multiplexing scheme is more suitable for recording more information on the recording medium than the coaxial scheme. However, the low shift selectivity of the angle multiplexing scheme disadvantageously prevents the recording spot from being accurately accessed. Thus, the present invention also utilizes the advantages of the coaxial scheme, which offers a high shift selectivity and which allows the manage information such as the address of the book to be simultaneously recorded. As a result, the apparatus according to the present embodiment can be provided with the advantages of the two schemes. Furthermore, the angle multiplexing scheme limits the arrangement of optical elements, inhibiting the difference Δθ in incident angle between the information light beam and the reference light beam from being reduced below a certain range. The apparatus according to the present embodiment uses even the angle area corresponding to the unavailable range of the incident angle difference, thus disadvantageously preventing angle multiplexed information from being affected.

### [Applied Examples of the Present Invention]

Description will be given of the operation of the apparatuses according to the embodiments to which the present invention is applied on the basis of the above description. First, in connection with the apparatuses according to the embodiments of the present invention, an embodiment will be described which uses a disc type recording medium and which is applied to the transmissive angle multiplexing scheme.

FIG. 16 shows the operation of the recording and reproducing apparatus in the recording mode. First, in step S1, the process of the recording operation is started to rotate the recording medium 1 around an axis perpendicular to the surface of the recording medium 11. Then, as shown in step S2, the focus servo is performed. For example, the servo light beam is directed to the recording medium 1. A reflected light beam from the recording medium 1 is detected by the above-described four-division photodetector 28 to detect the focus. In response to the detected focus signal, the focus servo is performed. The focus servo is maintained until the end of the recording operation shown in step S8. Then, as shown in step S3, the track servo is performed to specify the innermost peripheral track. The optical system is thus controlled such that the target beam spot is moved to the most inner peripheral portion of the disc. Subsequently, as shown in step S4, the reference light beam and the information light beam are emitted to the beam spot to record information in the same volume (book) at a high mechanical accuracy by multiple recording. After the information is recorded in the book, the reference light beam used for angle multiplexing is blocked using the shutter 47 as shown in step S5. Then, as shown in FIG. 3, a predetermined pattern is displayed on the spatial light modulator 11 in the reference light beam area and the information light beam area according to the coaxial scheme. As shown in step S6, the reference light beam and the information light beam are directed to the recording medium 11 by the light modulator 11 and thus emitted to the recording medium 1 to form a hologram.

In the specification, the reference light beam according to the coaxial scheme is referred to as the coaxial reference light beam. The information light beam according to the coaxial scheme is referred to as the coaxial information light beam. The hologram according to the coaxial scheme does not meet the black conditions even with the irradiation with the reference light beam used in the angle multiplexing recording mode. Thus, the hologram according to the coaxial scheme does not affect the reproduction light beam. The information pattern according to the coaxial scheme contains the address of the book, the number of the multiple holograms recorded by the angle multiplexing recording, and the incident angle of the reference light beam subjected to the angle multiplexing recording. Furthermore, the information pattern is characterized in that the same reference light beam pattern is set in the same track and in that the reference light beam pattern varies with the track. As shown in step S7, the axial hologram recording is performed in conjunction with the angle multiplexing recording to sequentially record pieces of information. In step 7, the recording is completed, and the recording operation is then completed.

Now, the reproducing operation in the reproduction mode will be described.

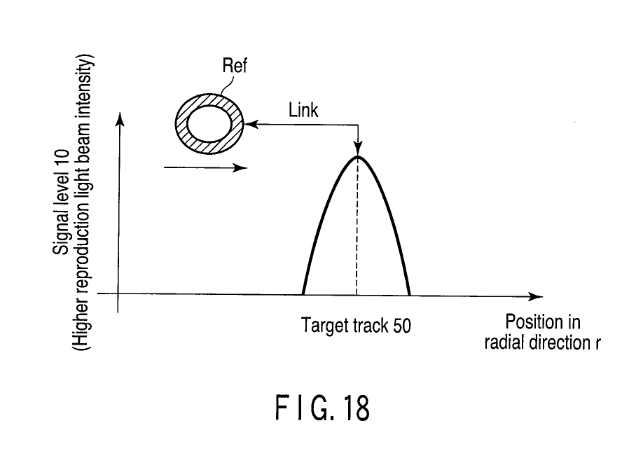

FIG. 17 shows the operation of the recording and reproducing apparatus in the reproduction mode. In the reproduction mode, first, in step S11, the process of the reproducing operation is started to rotate the recording medium 1 around the axis perpendicular to the surface of the recording medium 11. Then, as shown in step S12, the focus servo is performed, for example, according to a focus detecting method similar to that described above. The light beam for focus detection preferably has such a wavelength as avoids changing the optical characteristics of the recording medium 1. The focus servo is maintained until the end of the recording operation shown in step S21. Then, as shown in step S13, the optical system is controlled such that the target beam spot is moved to the innermost peripheral portion of the disc. More specifically, the recording medium 11 or the optical system including the objective lens 7 is moved and placed such that the beam spot is located at the innermost peripheral portion of the recording medium 1. Once the beam spot is formed in the target track, then as shown in step S14, the coaxial reference light beam is emitted to the recording medium 11 to allow the coaxial hologram to generate diffracted light as a reproduction light beam. The photodetector 30, which can perform quick detection, then detects the reproduction light beam. The coaxial reference light beam emitted in step S14 has a pattern specified for the target track 50. In this condition, as shown in FIG. 15, the disc 1 or the optical system is controllably moved so as to move the beam spot 49 in the radial direction (r) of the disc. Once the beam spot 49 reaches the target track, the reference light beam is periodically emitted to the photodetector 30 in conjunction with rotation Ro of the disc to generate a reproduction signal. Each peak of the reproducing optical signal corresponds to the position of the corresponding book recorded in the track 50. Thus, the reproduction signal is processed as a tracking error signal. As shown in FIG. 18, the optical system or the recording medium 1 is controlled such that the reproducing optical signal has the maximum value. That is in step S12, the focus and tracking servo optical system 76 performs servo to form the spot of the reference light beam in the target track 50. Then, in step S15, the reproducing optical signal from the photodetector 30 is supplied to the tracking servo system, which controls the objective lens 7 such that the reproducing optical signal has the maximum value. A pattern Ref of the reference light beam which is specified for each track 50 is determined. When this pattern is directed to the target track 50, a hologram is formed in the track 50 by this pattern and generates a reproduction light beam as shown in FIG. 18. As the reference light beam approaches the target track 50, the level of the reproduction light beam generated increases rapidly. Thus, provided that the reproduction light beam has the maximum intensity, the reference light beam accurately follows the track 50.

Tilt control is performed in conjunction with the tracking control as shown in step S16. In the tilt control, as described above with reference to FIGS. 13 and 14, the tilt angle is corrected such that the surface of the recording medium 1 aligns with the plane orthogonal to the optical axis of the reference light beam. Thus, the incident angle of the reproduction light beam according to the angle multiplexing scheme is corrected. The apparatus is thus ready for reproduction.

Obviously, the tilt correction is desirably similarly performed in the recording mode based on the angle multiplexing recording shown in step S4 in FIG. 16.

Once the apparatus is ready for the reproduction according to the angle multiplexing scheme, then as shown in step S17, the coaxial reference light beam is blocked using the shutter or the like. Subsequently, in the reproduction mode, the predetermined incident angle at which reproduction is performed by the coaxial reference beam is set. The reference light beam is directed to the recording medium 1 to reproduce the reproduction light beam from the book recorded by the angle multiplexing. As shown in step S19, a number of reproduction light beams are sequentially from the same track to reproduce data from the recorded book.

The apparatus determines in step S19 whether or not preset data has been reproduced. If the preset data has not been reproduced yet, the process returns to step S14. When the apparatus determines in step S19 that the preset data has been reproduced, the reproduction is completed in step S21.

### EXAMPLES

### Production of the Recording Medium

First, 3.86 g of vinyl carbazole and 2.22 g of vinyl pirolidone were mixed together. Then, 0.1 g of IRGACURE 784 (manufactured by Ciba Inc.) was added to the mixture, which was then agitated. After all the components were dissolved in the solution, 0.04 g of PARBUTYL H (NOF CORPORATION) was mixed into the solution to prepare a monomer solution A. Then, 10.1 g of 1, 4-butane butanediol diglycidyl diether and 3.6 g of diethylene triamine were mixed together to prepare an epoxy solution B. Then, 1.5 ml of monomer solution A and 8.5 ml of epoxy solution B were mixed together and defoamed to prepare an optical recording medium precursor. Separately prepared disc-like polycarbonate substrate was placed opposite the mixed solution. A uniform pressure was applied to the mixed solution to stretch the mixed solution to a thickness of 250 μm. Finally, the resulting structure was heated at 50° C. for 10 hours to produce a disc-like optical recording medium with a recording area of thickness 250 μm. A central portion of the optical recording medium was sandwichingly held with a magnetic clamp. Three dents were formed in the magnetic clamp. The optical recording medium 1 produced in the present example, the upper polycarbonate substrate formed the protective layer 2. In the present example, the series of operations were performed in a room for which light of wavelength shorter than 600 nm was blocked, so as to prevent the recording layer 3 from sensing light. (Production of the optical recording and reproducing apparatus)

First, optical recording and reproducing apparatuses configured as shown in FIG. 3 were produced. The objective lens 7 had a numerical aperture NA of 0.5. The optical recording and reproducing apparatuses were labeled as D and E, respectively. As the light source device 8, a gallium nitride-containing semiconductor laser device was used to produce an external resonator structure (oscillation wavelength: 403 to 405 nm). A semiconductor laser (wavelength: 650 nm) for linear polarization was used as the servo light source device 22. No external resonator was added to the semiconductor laser. A digital mirror device was used as the reflective spatial light modulator 11. A CCD array was used as the two-dimensional photodetector 20. A quarter wavelength plate with a wavelength of 405 nm was used as the rotary optical element 15. A quarter wavelength plate with a wavelength of 650 nm was used as the rotary optical element 25. The orientation of the quarter wavelength rotary optical element 15 was adjusted so as to maximize the intensity of the reproduction light beam on the two-dimensional photodetector 20. The orientation of the quarter wavelength rotary optical element 25 was adjusted so as to maximize the light intensity on the four-division photodetector 28.

### (Recording of Information)

Then, the optical recording medium 1 produced by the above-described method was mounted in the optical recording and reproducing apparatus D. Information was actually recorded on the optical recording medium 1. The recording medium was fixed to the apparatus at the three points on the magnetic clamp. The optical recording medium was rotated at 1 rpm. The light source 22 was used to perform the focus servo on the optical recording medium. With the laser 8 lighted and the galvano mirror 43 rotated, a hologram was recorded. The light intensity on the surface of the optical recording medium was 0.1 mW. The spot size of the laser beam, that is, the diameter of the spot, was 400 μm. An area on the digital mirror device 11 including 400×400=160,000 pixels was used. Adjacent 4×4=16 pixels were defined as one symbol. A 16:3 modulating method of defining 3 of the 16 pixels as bright points was used. The angle interval for angle multiplexing was set to 1°. Finally, the reference light beam was blocked using the shutter 19, and information was recorded in each block according to the coaxial scheme. At this time, the reference light beam pattern was the same within the track as described above.

### (Reproduction of Information)

The optical recording medium was rotated at 1 rpm. The light source 22 was used to perform the focus servo on the optical recording medium. With the laser 8 lighted, the coaxial reference light beam was displayed on the spatial light modulator 11 and emitted to the recording medium. At this time, the shutter 19 was blocked. The beam spot was moved to the central portion of the recording medium. Then, the beam spot was moved in the radial direction with the diffracted light intensity measured for each circumference by the photodetector 30. The movement was stopped at a position where the average diffracted light intensity for each circumference had the maximum value. The rotational driving device was moved up and down and rotated around the axis (b) as described above. The rotational driving device was stopped at the position where the diffracted light intensity had the maximum value. At this time, the angle φ at which the peak of the light intensity was observed within the track was measured. Then, the shutter 19 was opened, and the wavelength plate 40 was rotated so that all the beams were directed to the galvano mirror 43. The galvano mirror was rotated, and the signal intensity was measured by the photodetector 30. The galvano mirror was stopped at a position where the average intensity had the maximum value. The diffracted light was measured for each peak angle φ measured within the track by CCD 20. As a result, efficient reproduction was successfully achieved at the position where the diffracted light intensity had the maximum value within the track.

### (Reproduction by the Apparatus in the Comparative Example)

In the recording mode, recording was not performed according to the coaxial scheme. Reproduction was performed according to the angle multiplexing scheme. The track servo was performed using the reference light beam from the galvano mirror 43. As a result, for the track servo, no signal was obtained unless the galvano mirror was rotated. After the beam spot was aligned with the track, reproduction of the information in the track involved reproduction from the positions other than the one where the diffracted light intensity had the maximum value. Thus, efficient reproduction was not successfully achieved.

As described above, the hologram optical recording and reproducing apparatus and method according to the present invention using the holography, particularly the volume holography, enables the tracking and tilt servo and improves the efficiency in the reproduction mode.

The optical recording and reproducing method and apparatus in the above-described example records multiple data in the same volume with a high angle selectivity as holograms according to the angle multiplexing scheme. Furthermore, management information such as the angle information is recorded in the same book as highly position-selective holograms according to the coaxial interfering scheme. In the reproduction mode according to the coaxial interfering scheme, reproduced detection signals can be used as tracking and tilt servo signals, enabling efficient reproduction without the need to add any optical component. Furthermore, the management information for the angle multiplexing recording is read from the highly position-selective hologram signals. The management information can be utilized to efficiently reproduce the angle multiplexed information. The transfer rate can thus be improved. As a result, with the hologram optical recording and reproducing apparatus utilizing the holography, particularly the volume holography, the tracking and tilt servo can be achieved by utilizing the reproduction light beam according to the coaxial interfering scheme. Furthermore, the efficiency in the reproduction mode according to the angle multiplexing scheme can be improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical information reproducing apparatus comprising:
an optical recording medium having an optical recording layer in which a first hologram is formed by optical coaxial interference and in which a second hologram is formed by angle multiplexing interference in an area in which the first hologram is recorded;
a light source which generates a coherent light beam;
a first optical system which applies a first reference pattern to the light beam to generate a first reference light beam and irradiates the first hologram with the first reference light beam to generate a first reproduction light beam including a recording pattern in a first reproduction mode;
a reproducing part which detects the first reproduction light beam to read the recording pattern contained in the first reproduction light beam and extract a particular incident angle for setting a second reference light beam from the recording pattern; and
a second optical system which applies a preset directionality to the light beam according to the particular incident angle to generate the second reference light beam in a second reproduction mode, the second reproducing optical system allowing the second reference light beam to enter the second hologram at the particular incident angle to generate a second reproduction light beam so that the reproducing part reproduces a reproduction signal.

2. The optical reproducing apparatus according to claim 1, wherein the number of a multiplicity of the second holograms recorded, an address of each second hologram, and the particular incident angle prepared for each of the second holograms are recorded in the first hologram as management information.

3. The optical reproducing apparatus according to claim 1, wherein the optical recording medium has tracks for guiding the first reference light beam, and the first reference pattern is specified for each of the tracks as a specific pattern.

4. The optical reproducing apparatus according to claim 1, wherein the optical recording medium has a track in which the first hologram is formed,
the reproducing part detects the first reproduction light beam to generate a detection signal, and
the apparatus further comprises a tracking servo mechanism which allows the first reference light beam to follow the track on the basis of the detection signal.

5. The optical reproducing apparatus according to claim 1, wherein the reproducing part detects the first reproduction light beam to generate a detection signal, and
the apparatus further comprises a tilt correcting mechanism which corrects tilt of the optical recording medium on the basis of the detection signal.

6. The optical reproducing apparatus according to claim 1, wherein the second hologram is recorded in a recording mode in which a recording beam is set at the particular incident angle.

7. The optical reproducing apparatus according to claim 6, wherein the first hologram is recorded with high position selectivity.

8. The optical reproducing apparatus according to claim 2, wherein the management information includes information on the address at which each second hologram is recorded.

9. An optical information recording apparatus comprising:
an optical recording medium having an optical recording layer in which a first hologram is formed by optical coaxial interference and in which a second hologram is formed by angle multiplexing interference in an area in which the first hologram is recorded;
a light source which generates a coherent light beam;
a first optical system which spatially separates the light beam to coaxially generate a first recording light beam having a recording pattern corresponding to first recording information which includes a particular incident angle, and a first reference light beam having a first reference pattern in a first recording mode, the first reproducing optical system allowing the first reference light beam and the first recording light beam to interfere with each other in the area to form the first hologram in the area; and
a second optical system which separates the light beam into a second reference light beam and a second recording light beam having a recording pattern corresponding to second recording information in a second recording mode, the second reproducing optical system allowing the second reference light beam to enter the area at the particular incident angle so that the second reference light beam and the second recording light beam interfere with each other to form the second hologram.

10. The optical recording and reproducing apparatus according to claim 8, wherein the number of a multiplicity of the second holograms recorded, an address of each second hologram, and the particular incident angle prepared for each of the second holograms are recorded in the first hologram as management information.

11. The optical recording and reproducing apparatus according to claim 8, wherein the optical recording medium has tracks for guiding the first recording light beam, and the first reference pattern is specified for each of the tracks as a specific pattern.

12. The optical recording and reproducing apparatus according to claim 8, further comprising:
a data generating unit which generating the first recording information including the particular incident angle in the first recording information.

13. An optical information reproducing method comprising:
irradiating a first hologram formed on an optical recording medium by optical coaxial interference, with a first reference light beam containing a first reference pattern to generate a first reproduction light beam in a first reproduction mode;
detecting the first reproduction light beam to read a recording pattern and extract a particular incident angle for setting a second reference light beam from the recording pattern;
allowing the second reference light beam to enter a multiplicity of the second holograms formed in an area, in which the first hologram is formed, at the particular incident angle in the second reproduction mode to generate a second reproduction light beam; and
reproducing a reproduction signal from the second reproduction light beam to reproduce information.

14. The optical recording and reproducing method according to claim 12, wherein the number of the multiplicity of second holograms recorded, an address of each second hologram, and the particular incident angle prepared for each of the second holograms are recorded in the first hologram as management information.

15. The optical recording and reproducing method according to claim 12, wherein the optical recording medium has tracks for guiding the first reproduction light beam, and the first reference pattern is specified for each of the tracks as a specific pattern.

16. The optical recording and reproducing method according to claim 13, wherein the management information includes information on the address at which each second hologram is recorded.

17. An optical information recording method comprising:
generating a first reference light beam and a first recording light beam having a recording pattern corresponding to first recording information in a first recording mode, the first recording information including a particular incident angle;
allowing the first reference light beam to enter an area of a recording medium at the particular incident angle so that the first reference light beam and the first recording light beam interfere with each other to form a first hologram in the area; and
generating a second recording light beam having a recording pattern corresponding to the management data and a second reference light beam spatially separated from the second recording light beam in a second recording mod, and allowing the second reference light beam and the second recording light beam to interfere with each other to form a second hologram in the area to record the first and second hologram in the same area.

18. The optical recording and reproducing method according to claim 16, wherein the number of the multiplicity of second holograms recorded, an address of each second hologram, and the particular incident angle prepared for each of the second holograms are recorded in the first hologram as management information.

19. The optical recording and reproducing method according to claim 16, wherein the optical recording medium has tracks for guiding the first recording light beam, and the first reference pattern is specified for each of the tracks as a specific pattern.

20. The optical recording and reproducing method according to claim 16, further comprising:
generating management data including the particular incident angle.
